(19) United States
(12) Patent Application Publication
(10) Pub. No.: US 2007/0090231 A1
(43) Pub. Date: Apr. 26, 2007

(54) Multi-purpose hanger for pipe, tubing, conduit or cable and method of using same

(76) Inventor: James MacDuff, Victoria (CA)

Correspondence Address: DORITY & MANNING, P.A., POST OFFICE BOX 1449, GREENVILLE, SC, 29602-1449, US

(21) Appl. No.: 11/259,512

(22) Filed: Oct. 26, 2005

(51) Int. Cl. F16L 3/00

(52) U.S. Cl. 248/62; 248/71; 248/74.1

(57) ABSTRACT

A multi-purpose hanger includes a helical support structure for supporting pipe, tubing, conduit or cable against a support surface in any one of a plurality of orientations. The hanger includes an anchor block to which the helical support structure is affixed. The helical support structure spirals 360° between first and second ends to define a gap between the first and second ends that is about equal to an outer diameter of the pipe.

### CROSS-REFERENCE TO RELATED APPLICATIONS

This is the first application filed for the present invention.

### MICROFICHE APPENDIX

Not Applicable.

### TECHNICAL FIELD

The present invention relates generally to hangers for supporting runs of cylindrical objects and, in particular, to multi-purpose hangers for supporting pipe, tubing, conduit, cable and the like.

### BACKGROUND OF THE INVENTION

Pipe hangers for hanging pipes, tubing or water lines are well known in the art. Pipe hangers, also known as “pipe support structures”, are connectors that fix or restrain piping/tubing to a support surface, such as to floor joists or wall studs, to route the piping/tubing for plumbing, or to provide a closed-loop circuit for a hydronic heating system, or other such application.

However, as is known in the art, the prior-art pipe hangers are generally awkward and time-consuming to install. Furthermore, these prior-art pipe hangers are typically designed to restrain pipe in only one orientation, i.e. generally either in a horizontal or a vertical orientation. Therefore, different hangers must be used for different applications and different orientations in the same run.

Furthermore, prior-art pipe hangers are generally designed for only supporting pipe and are not generally suitable for supporting electrical cable, while cable hangers are generally not suited for supporting pipe, Therefore, different types of hangers are typically required when installing a run of pipe, tubing, conduit or cable.

Accordingly, it is highly desirable to provide an improved, “multi-purpose” hanger for supporting pipe, tubing, conduit or cable in order to overcome at least one of the deficiencies of the prior art.

### SUMMARY OF THE INVENTION

It is therefore an object of the invention to provide an improved, multi-purpose hanger for supporting or restraining pipe, tubing, conduit or cable.

The invention therefore provides a multi-purpose hanger comprising a helical support structure that is placed around an outer surface of the pipe, tubing, conduit or cable, such as, but not limited to, pipe, tubing, conduit and cable. The helical support structure is truncated at first and second “free” ends. The first and second ends are spaced apart and form a gap that is about equal to (or slightly smaller than) an outer diameter of the pipe, tubing, conduit or cable. The gap between the ends of the helical support structure facilitate placing the helical support structure over the pipe, tubing, conduit or cable while providing superior retention of the pipe, tubing, conduit or cable after the hanger is secured to a rigid structure such as a floor joist or wall stud. Accordingly, the multi-purpose hanger in accordance with the present invention simplifies the task of installing pipe, tubing, conduit or cable. Furthermore, the multi-purpose hanger can be secured to a support structure (e.g. floor joist or wall stud) in one of a plurality of orientations. Therefore, an entire run of pipe, tubing, conduit or cable can be hung or restrained using a number of the multi-purpose hangers by securing the hangers at suitable intervals in any required orientation.

The invention therefore provides a multi-purpose hanger for supporting a run of pipe, tubing, conduit or cable in any orientation. The hanger includes an anchor block for securing the hanger to a support surface; and a substantially helical support structure for supporting the pipe, tubing, conduit or cable, the helical support structure having first and second ends that define a gap that is about equal to an outer diameter of the pipe, tubing, conduit or cable.

The invention further provides a method of restraining a pipe, tubing, conduit or cable relative to a support surface. The method includes steps of placing a multi-purpose hanger over the pipe, tubing, conduit or cable, the hanger having a helical support structure with opposite ends spaced apart from each other that form a gap that is about equal to an outer diameter of the pipe, tubing, conduit or cable, to permit the pipe, tubing, conduit or cable to be slid through the gap, after which the hanger is rotated about 45° to restrain the pipe, tubing, conduit or cable within the helical support structure; and securing the hanger to the support surface to restrain the pipe, tubing, conduit or cable.

The invention further provides a multi-purpose hanger for supporting a pipe, tubing, conduit or cable. The hanger includes an anchor block securable to a rigid surface; and a helical support structure affixed to the anchor block, the helical support structure spiraling through 360° between first and second ends, the first and second ends being spaced apart to form a gap at least sufficient to permit the helical support structure to be slid over the pipe, tubing, conduit or cable by passing same between the first and second ends, and thereafter rotating the hanger to restrain the pipe, tubing, conduit or cable within the helical support structure when the hanger is secured to the rigid surface.

### BRIEF DESCRIPTION OF THE DRAWINGS

Further features and advantages of the present invention will become apparent from the following detailed description, taken in combination with the appended drawings, in which:

FIG. 1 is an end elevational view of a multi-purpose hanger in accordance with an embodiment of the invention;

FIG. 2 is a bottom plan view of the multi-purpose hanger shown in FIG. 1;

FIG. 3 is a top plan view of the multi-purpose hanger shown in FIG. 1;

FIG. 4 is a side elevational view of the multi-purpose hanger shown in FIG. 1;

FIG. 5 is an isometric perspective view of the multi-purpose hanger in accordance with another embodiment of the invention;

FIG. 6 is and end elevational view of the multi-purpose hanger restraining a pipe, tubing, conduit or cable against a support surface such as a sub floor, in accordance with an embodiment of the invention;

FIG. 7 is a bottom plan view of the multi-purpose hanger shown supporting a pipe, tubing, conduit or cable in the same orientation shown in FIG. 6;

FIG. 8 is an end elevational view of the multipurpose hanger in accordance with the invention shown supporting a pipe, tubing, conduit or cable running through a bore through a floor joist; and

FIG. 9 is a side elevational view of the multipurpose hanger shown in FIG. 8.

It should be noted that throughout the appended drawings, like features are identified by like reference numerals.

### DETAILED DESCRIPTION OF PREFERRED EMBODIMENTS

The invention provides a multi-purpose hanger for hanging, supporting or otherwise restraining a pipe, tubing, conduit cable or the like. The hanger includes a helical support structure connected to an anchor block. The helical support structure is quickly and easily placed over the pipe, tubing, conduit or cable without disassembly of any parts, yet securely supports the pipe, tubing, conduit or cable after it is secured to a support surface using a fastener. In one embodiment the anchor block is provided with a plurality of passages for receiving fasteners to permit the multi-purpose hanger to be mounted to the rigid surface in a plurality of orientations.

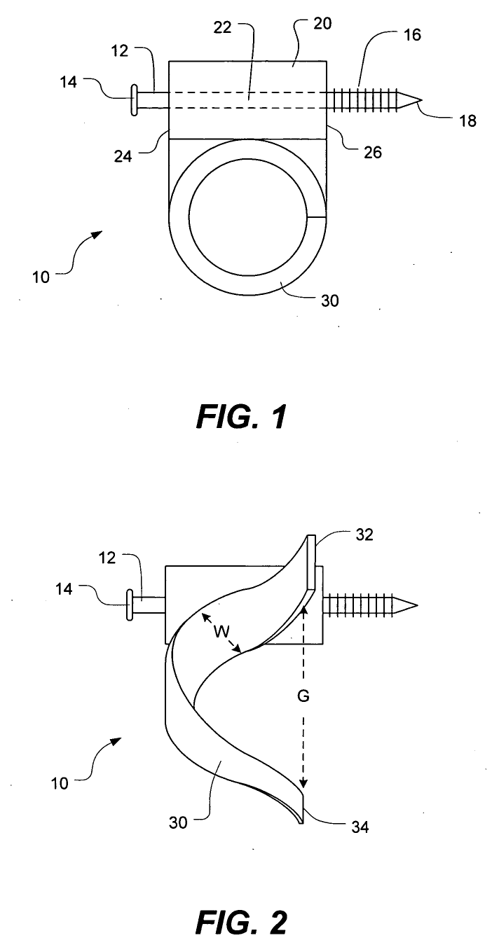

FIG. 1 is en end elevational view of a multi-purpose hanger, generally designated by reference numeral 10, in accordance with an embodiment of the invention. As shown in FIG. 1, the hanger 10 includes an anchor block 20 to permit the hanger 10 to be connected to a support surface, which may be a structure such as a floor joist, wall stud, sub floor, etc. As shown, in one embodiment the anchor block 20 is a rectangular polyhedron that can receive a fastener 12 such as a ring-shank nail (also known as an “annular nail”). The ring-shank nail has a substantially flat head 14 and a ringed shank 16 that terminates in a pointed tip 18. As will be readily appreciated by those of ordinary skill in the art, many other types of fasteners can be used to secure the hanger to the support surface, depending on the material of an underlying structure and on a load that each hanger is expected to bear. Such fasteners include screws, rivets, bolts and staples.

The anchor block 20 includes at least one passage 22 through which the fastener 12 is inserted in order to secure the hanger to the support surface. The anchor block 20 also includes a pair of substantially flat end faces 24, 26. The flat end faces 24, 26 enable the hanger 10 to be secured flush against a flat support surface when the fastener 12 is inserted through an axial passage 22a through the anchor block 20, such as, for example, a side face of a floor joist.

As shown in FIGS. 2 to 4, the hanger 10 further includes a substantially helical support structure 30 which is connected to the anchor block 20. The helical support structure 30 is shaped to support a pipe, tubing, conduit or cable. The hanger 10 can be manufactured as one integral component using plastic injection molding techniques, for example. The hanger 10 can also be manufactured by molding the helical support structure 30 and support 20 separately and then rigidly affixing the helical support structure 30 to the support 20 using a suitable adhesive or fastener. Alternatively, the hanger 10 can be cast from a white metal or steel, or constructed from separate metal parts that are spot-welded, welded, brazed or mechanically fastened together using methods well known in the art.

As shown in FIGS. 2 to 4, the helical support structure 30 has a first end 32 and a second end 34. The helical support structure 30 spirals between the first end 32 and the second end 34 to define a gap G between the first and second ends 32, 34. In one embodiment, the gap G is about equal to an outer diameter of the pipe, tubing, conduit or cable to be supported. In another embodiment, the gap G is larger than the outer diameter of the pipe, tubing, conduit or cable to be supported. In yet another embodiment the gap G is slightly smaller than the pipe, tubing, conduit or cable.

Referring back to FIG. 1, the helical support structure 30 spirals through 360° between the first and second ends 32, 34. When viewed from the end, therefore, the helical support structure 30 defines a circle as shown in FIG. 1.

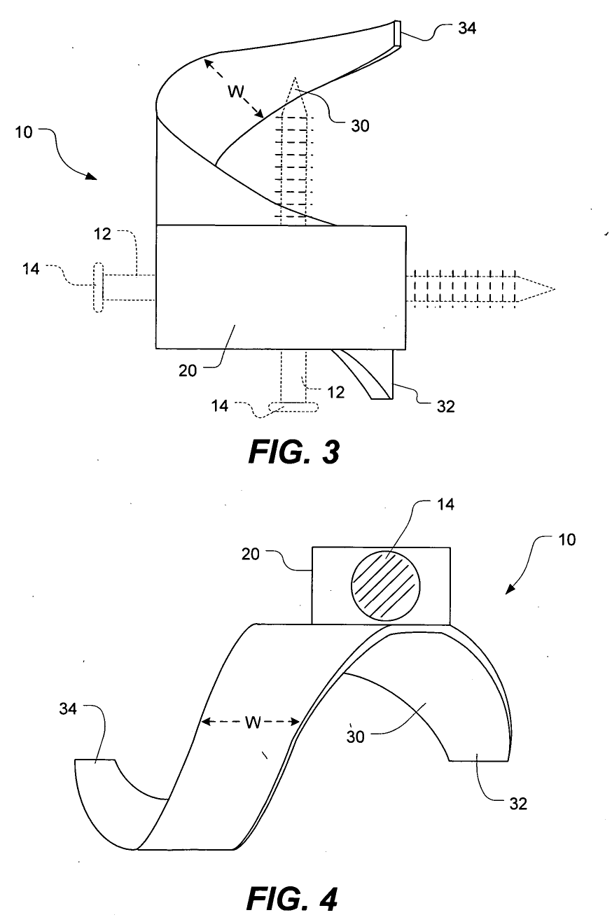

In one embodiment shown in FIG. 2, the helical support structure 30 has an average width W about equal to half the outer diameter of the pipe, tubing, conduit or cable. As shown in FIG. 3, in one embodiment the anchor block 20 includes at least one radial passage for accommodating a fastener 12.

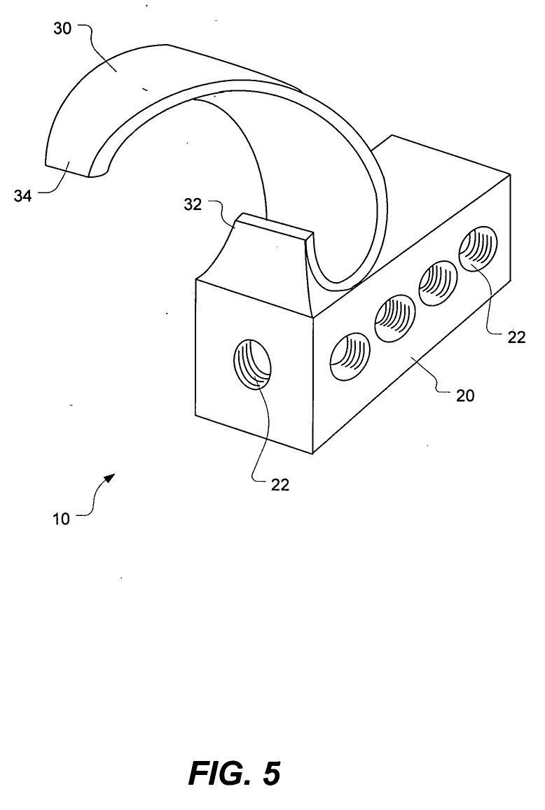

FIG. 5 is an isometric perspective view of the multi-purpose hanger 10 in accordance with an embodiment of the invention, oriented so that the helical support structure 30 is above the anchor block 20. In this embodiment, the anchor block 20 is provided with a plurality of passages 22 through which a fastener 12 can be inserted. As explained below with reference to FIG. 9, the passages 20 can be oriented at different angles with respect to faces of the anchor block 20 to provide more versatility in affixing the anchor block to a support surface.

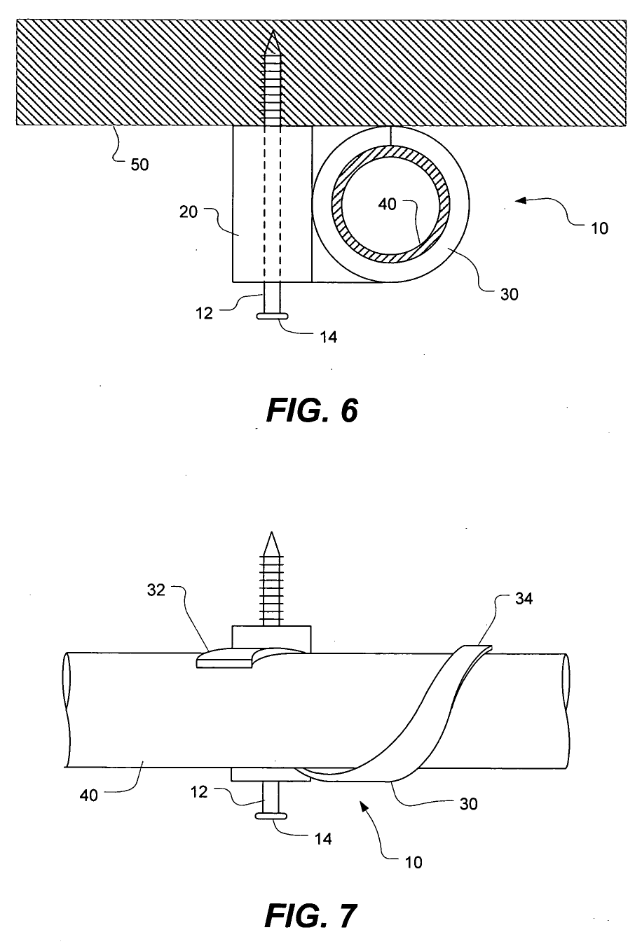

FIGS. 6 and 7 are an end elevational view and a bottom plan view, respectively, of a multi-purpose hanger 10 oriented so that the helical support structure 30 is on one side the anchor block 20. The hanger 10 could be in this orientation, for example, to restrain a pipe, tubing, conduit or cable 40 against, or in close proximity to, a support surface 50.

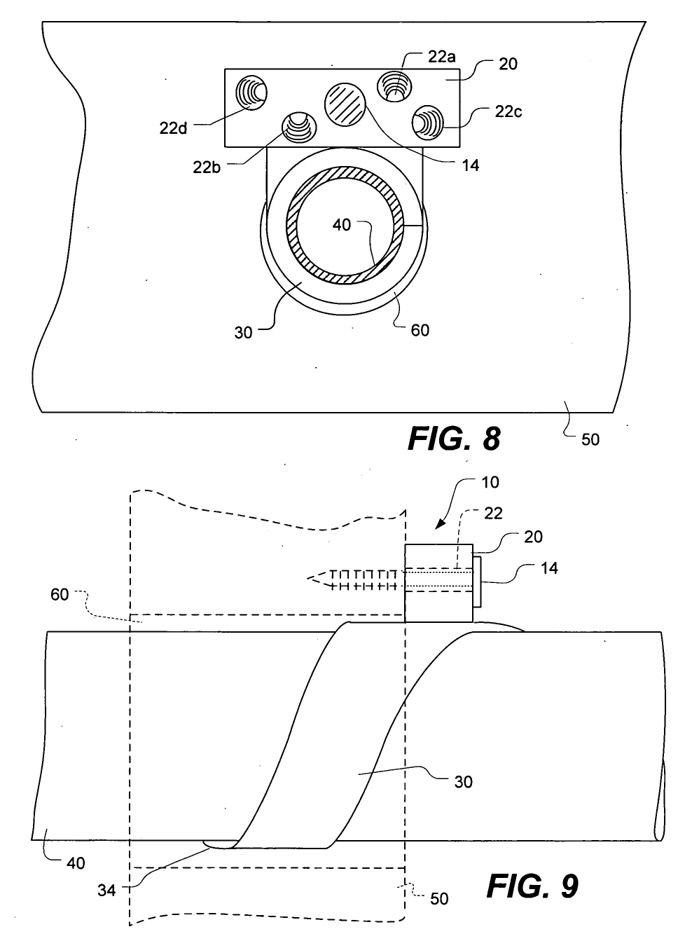

FIGS. 8 and 9 are respectively an end elevational view and a side elevational view of an embodiment of the hanger 10 in accordance with the invention in use for supporting a pipe, tubing, conduit or cable 40 that is run through a bore in a structural member 50 such as a floor joist. As is known in the art, certain building inspectors require that pipe or tubing run through a bore 60 through a structural member 50 be supported to prevent contact with a bottom of the bore. The hanger 10 is perfectly suited for this application so long as the bore 60 is larger than an outer diameter of the helical support structure 30. As shown in FIG. 9, the second end 34 of the helical support structure 30 is inserted into the bore 60 and a fastener having a head 14 is driving through one of the passages 22 in a face of the anchor block 20 to support the pipe or tubing 40 above a bottom of the bore 60.

In this embodiment, the passages 22 have two or more different orientations. For example, some of the passages 22a may be angled downwardly with respect to one face of the anchor block 20, while other passages may be angled upwardly 22b or laterally 22c, 22d. This provides more flexibility when securing the anchor block 20 and also permits two fasteners to be driven at different angles to increase holding power when required.

The multi-purpose hanger 10 can be used to restrain a pipe, tubing, conduit or cable relative to a support surface in any one of a plurality of orientations. For example, the hanger 10 can be used to support pipe, tubing, conduit or cable 40 horizontally against the face of a floor joist, or vertically along the face of a wall stud. Alternatively, the multi-purpose hanger 10 can be used to support the pipe, tubing, conduit or cable 40 in oblique orientations, i.e. at any one of various angles between the vertical and the horizontal. Furthermore, the hanger 10 can be secured to a support surface with the gap G facing toward or away from the support surface 50.

In operation, the multi-purpose hanger 10 is connected to the pipe, tubing, conduit or cable 40 by aligning the gap G of the helical support structure 30 with the pipe, tubing, conduit or cable 40, sliding the hanger 10 over the pipe, tubing, conduit or cable 40 and rotating the hanger 10 (and hence the helical support structure 30) relative to the pipe, tubing, conduit or cable 40 to align the helical support structure with the pipe, tubing, conduit or cable 40. Once the pipe, tubing, conduit or cable 40 is slid/pressed through the gap G, the hanger 10 is rotated about 45° to align the pipe, tubing, conduit or cable 40 with the helical support structure 30. The hanger 10 is then secured to the support surface 50 (e.g. floor joist, wall stud, sub floor, etc) so as to support the pipe, tubing, conduit or cable 40.

In one embodiment, the hanger 10 is secured to the structure 50 by inserting a fastener 12, such as a nail or screw, through the passage 22 in the anchor block 20 and driving the fastener 12 into the support surface 50.

The multi-purpose hanger 10 can be used to secure or restrain a run of pipe or tubing for a domestic or commercial plumbing application or a hydronic heating system. Alternatively, the multi-purpose hanger 10 can be used to support an electrical conduit, cable or a bundle of cables or wires. As will be appreciated by those skilled in the art, the number of multi-purpose hangers 10 needed to hang a run of pipe, tubing, conduit or cable 40, as well as an appropriate inter-hanger spacing (i.e. an interval between adjacent hangers) depends on the type and strength of the support surface 40 to which the hanger 10 is to be attached, the type of fastener used (e.g. screw, ring-shank nail, spiral nail or common nail, bolt, rivet or staple) and the load that each hanger is to bear.

The embodiments of the invention described above are intended to be exemplary only. The scope of the invention is therefore intended to be limited solely by the appended claims.

I/WE claim:

1. A multi-purpose hanger for supporting an elongated pipe, tubing, conduit or cable in any one of a plurality of orientations, the hanger comprising:
an anchor block for receiving a fastener for securing the hanger to a support surface; and
a helical support structure rigidly connected to the anchor block for supporting the pipe, tubing, conduit or cable, the helical support structure having first and second ends separated by a gap that permits the helical support structure to be placed over the pipe, tubing, conduit or cable.

2. The multi-purpose hanger as claimed in claim 1 wherein the helical support structure spirals through 360° between the first and second ends.

3. The multi-purpose hanger as claimed in claim 1 wherein the anchor block comprises a plurality of passages for receiving the fastener to permit the anchor block to be secured to the rigid structure in a plurality of orientations.

4. The multi-purpose hanger as claimed in claim 3 wherein the anchor block comprises at least one axial passage for receiving the fastener.

5. The multi-purpose hanger as claimed in claim 3 wherein the anchor block comprises at least one radial passage for receiving the fastener.

6. The multi-purpose hanger as claimed in claim 1
wherein the anchor block and the helical support structure comprise an integral structure.

7. The multi-purpose hanger as claimed in claim 1
wherein the anchor block and the helical support structure comprise separate parts that are rigidly interconnected.

8. The multi-purpose hanger as claimed in claim 1
wherein the anchor block comprises a rectangular polyhedron having at least three flat sides to facilitate mounting the multi-purpose hanger to the support surface in a plurality of orientations.

9. A method of restraining a pipe, tubing, conduit or cable relative to a rigid structure, the method comprising steps of:
placing a multi-purpose hanger over the pipe, tubing, conduit or cable, the multi-purpose hanger comprising a helical support structure and an anchor block, the helical support structure having opposite ends spaced apart from each other to form a gap that permits the pipe, tubing, conduit or cable to be slid into the helical support structure;
rotating the helical support structure about 45° to align the pipe, tubing, conduit or cable within the helical support structure; and
securing the anchor block to a support surface using at least one fastener inserted through a passage through the anchor block and driven into the support surface.

10. The method as claimed in claim 9 wherein securing the anchor block comprises inserting a nail into the passage through the anchor block and driving the nail into the support surface.

11. The method as claimed in claim 9 wherein securing the anchor block comprises inserting a screw into the passage through the anchor block and driving the screw into the support surface.

12. A multi-purpose hanger for supporting a pipe, tubing, conduit or cable, comprising:
an anchor block that can be secured to a support surface using a fastener; and
a helical support structure connected to the anchor block, the helical support structure having first and second spaced apart ends that form a gap sufficient to permit the helical support structure to be placed over the pipe, tubing, conduit or cable by passing the pipe, tubing, conduit or cable between the first and second ends, and thereafter rotating the hanger to restrain the pipe, tubing, conduit or cable within the helical support structure when the hanger is secured to the support surface.

13. The multi-purpose hanger as claimed in claim 12 wherein the hanger is rotated 45° from a position in which it is placed over the pipe, tubing, conduit or cable in order to restrain the pipe, tubing, conduit or cable.

14. The multi-purpose hanger as claimed in claim 12 wherein the anchor block comprises a plurality of passages for respectively receiving a fastener for securing the hanger to the support surface.

15. The multi-purpose pipe hanger as claimed in claim 14 wherein the anchor block comprises a pair of substantially flat end faces and an axial passage through the anchor block for receiving the fastener, whereby the fastener can be inserted into the axial passage from either end face to secure the hanger flush against the support surface in either a first orientation in which the gap faces the rigid surface and a second orientation in which the gap faces away from the rigid surface.

16. The multi-purpose pipe hanger as claimed in claim 15 wherein the anchor block further comprises first and second flat side surfaces and a plurality of radial passages through the anchor block that communicate with the respective first and second side surfaces, whereby the fastener can be inserted into any one of the radial passages from either end side face to secure the hanger to the rigid surface.

17. The multi-purpose hanger as claimed in claim 12 wherein the anchor block and the helical support structure are integrally formed.

18. The multipurpose hanger as claimed in claim 12 wherein the anchor block and the helical support are separately formed and rigidly interconnected.

19. The multipurpose hanger as claimed in claim 18 wherein the anchor block and the helical support are molded metal and welded together.

20. The multipurpose hanger as claimed in claim 18 wherein the anchor block and the helical support are formed from plastic and bonded together.
